(19) United States
(12) Patent Application Publication
(10) Pub. No.: US 2019/0205020 A1
(43) Pub. Date: Jul. 4, 2019

(54) ADAPTIVE USER INTERFACE SYSTEM

(71) Applicant: Neal Fairbanks, Livonia, MI (US)

(72) Inventor: Neal Fairbanks, Livonia, MI (US)

(21) Appl. No.: 16/288,366

(22) Filed: Feb. 28, 2019

Related U.S. Application Data
(63) Continuation-in-part of application No. 13/925,168, filed on Jun. 24, 2013, now abandoned.
(60) Provisional application No. 61/680,897, filed on Aug. 8, 2012.

(51) Int. Cl. G06F 3/0484; G11B 27/036

(52) U.S. Cl. CPC G06F 3/04845; G11B 27/036; G06F 3/04842

(57) ABSTRACT

An adaptive user interface system may include a user interface device with memory and a processor communicatively connected to the memory to provide operations. The operations may include to receive media content and interactive content, correlate the media content and the interactive content, define an object boundary relative to one or more objects in media content, define interactive regions having a predefined gap relative to the object boundary, and display media content while hiding the interactive regions.

### CROSS-REFERENCE TO RELATED APPLICATIONS

This continuation-in-part application is based on and claims priority to U.S. Non-Provisional Patent Application Ser. No. 13/925,168, filed Jun. 24, 2013, which is based on and claims priority to U.S. Provisional Patent Application No. 61/680,897, filed Aug. 8, 2012, each of which is incorporated by reference in its entirety.

### TECHNICAL FIELD

The disclosure generally relates to systems, devices and methods for providing an adaptive user interface and enabling and enhancing interactivity with respect to objects in media content. For example, these may include providing and adapting additional or interactive information associated with an object visually present in media content in response to selection of the object in the media content by one or a plurality of user interface devices.

### BACKGROUND

Media content, such as television media content, is typically broadcasted by a content provider to an end-user. Embedded within the media content are a plurality of objects. The objects traditionally are segments of the media content that are visible during playback of the media content. As an example, without being limited thereto, the object may be an article of clothing or a household object displayed during playback of the media content. It is desirable to provide additional information, such as interactive content, target content and advertising information, in association with the object in response to selection or “clicking” of the object in the media content by the end-user.

There have been attempts to provide such interactivity to objects in media content. These attempts traditionally require physical manipulation of the object or the media content. For example, some methods require the media content to be edited frame-by-frame to add interactivity to the object. Moreover, frame-by-frame editing often requires manipulation of the actual media content itself. But, manipulating the media content itself is largely undesirable. One issue presented in creating these interactive objects is interleaving it with the media stream. Faced with this issue, traditional techniques include transmitting the interactive objects in video blanking intervals (VBI) associated with the media content. In other words, if the video is being transmitted at 30 frames per second (a half hour media content contains over 100,000 frames), only about 22 frames actually contain the media content. This leaves frames that are considered blank and one or two of these individual frames receives the interactive object data. Since the frames are passing at such a rate, the user or viewer upon seeing the hot spot and wishing to select it, will select it for a long enough period of time such that a blank frame having the hot spot data will pass during this period. Other methods include editing only selected frames of the media stream, instead of editing each of the individual frames. However, even if two frames per second were edited, for a half-hour media stream, 3,600 frames would have to be edited. This would take considerable time and effort even for a most skilled editor.

Another attempt entails disposing over the media content a layer having a physical region that tracks the object in the media content during playback and detecting a click within the physical region. This method overlays the physical regions in the media content. Mainly, the layer had to be attached to the media content to provide additional “front-end” processing. Thus, this attempt could not instantaneously provide the additional information to the end-user unless the physical region was positioned in a layer over the object.

Accordingly, it would be advantageous to provide systems, devices and methods to overcome these shortcomings in the art.

### BRIEF DESCRIPTION OF THE DRAWINGS

Advantages of the present disclosure will be readily appreciated, as the same becomes better understood by reference to the following detailed description when considered in connection with the accompanying drawings.

FIG. 1 is an illustrative system for providing additional information associated with an object visually present in media content in response to selection of the object in the media content by a user;

FIG. 2 is an illustration of an editor that enables a region to be defined temporarily in relation to the object such that object parameters associated with the object can be established and stored in a database;

FIG. 3 is an illustration of a player whereby the additional information is displayed to the user if selection event parameters corresponding to the user's selection of the object are within the object parameters;

FIG. 4 is a flow chart representing the method for providing additional information associated with the object visually present in media content in response to selection of the object in the media content by the user;

FIG. 5 illustrates an exemplary network system of the present disclosure including, for example, a network connecting user interface devices and servers;

FIG. 6 illustrates an exemplary operational relationship between a program, a server, and a database of the present disclosure;

FIG. 7 illustrates an exemplary communication flow of the present disclosure;

FIG. 8 illustrates an exemplary adaptive user interface of the present disclosure;

FIG. 9 illustrates another exemplary adaptive user interface of the present disclosure;

FIG. 10 illustrates another exemplary adaptive user interface of the present disclosure;

FIG. 11 illustrates another exemplary adaptive user interface of the present disclosure;

FIG. 12 illustrates another exemplary user interface of the present disclosure;

FIG. 13 illustrates another exemplary user interface of the present disclosure;

FIG. 14 illustrates an exemplary process of the present disclosure; and

FIG. 15 illustrates another exemplary process of the present disclosure.

### DETAILED DESCRIPTION

This disclosure provides systems, user interface devices and computer-implemented methods for providing additional information associated with an object visually present in media content in response to selection of the object in the media content by a user. The method includes the step of establishing object parameters comprising user-defined time and user-defined positional data associated with the object. The object parameters are stored in a database. The object parameters are linked with the additional information. Selection event parameters are received in response to a selection event by the user selecting the object in the media content during playback of the media content. The selection event parameters include selection time and selection positional data corresponding to the selection event. The selection event parameters are compared to the object parameters in the database. The method includes the step of determining whether the selection event parameters are within the object parameters. The additional information is retrieved if the selection event parameters are within the object parameters such that the additional information is displayable to the user without interfering with playback of the media content.

Accordingly, the method advantageously provides interactivity to the object in the media content to allow the user to see additional information such as advertisements in response to clicking the object in the media content. The method beneficially requires no frame-by-frame editing of the media content to add interactivity to the object. As such, the method provides a highly efficient way to provide the additional information in response to the user's selection of the object. Furthermore, the method does not require a layer having a physical region that tracks the object in the media content during playback. Instead, the method establishes and analyzes object parameters in the database upon the occurrence of the selection event. The method takes advantage of the computer processing power to advantageously provide interactivity to the object through a “back-end” approach that is advantageously hidden from the media content and user viewing the media content. Additionally, the method efficiently processes the selection event parameters and does not require continuous synchronization of between the object parameters in the database and the media content. In other words, the method advantageously references the object parameters in the database when needed, thereby minimizing adverse performance on the user device, the player, and the media content.

Embodiments may include systems, user interface devices and methods to provide the operations disclosed herein. This may include receiving, by an end-viewer device having a user interface and being in communication with a server, media content with an object; establishing, without accessing individual frames of media content, a region by drawing an outline spaced from and along an edge of the object as visually presented in the media content; establishing, while the region is temporarily drawn in relation to the object, object parameters including a user-defined time and a user-defined position associated with the object; linking the object parameters with additional information; transmitting, by the end-viewer device, selection event parameters including a selection time and a selection position in response to a selection event by the end-viewer device selecting the object in the media content during playback of the media content while the object parameters are hidden; retrieving the additional information if the selection event parameters correspond to the object parameters; and displaying, by the user interface of the end-viewer device, the media content in a first window and the additional information in a second window separated from the first window by a space and that expands from the region of the selection event by the end-viewer device without interfering with playback of the media content. The outline of the region may surround and correspond to the object while providing an excess space (e.g., predefined, varying or substantially constant gap or distance) between the edge of the object and an edge of the region.

The establishing of object parameters may be defined as establishing object parameters associated with the region defined in relation to the object according to any or each of: a uniform resource locator (URL) input field for a link to a website with additional information of the object, a description input field for written information including a message describing the object and a promotion related to the object, a logo input field for at least one of an image, logo, and icon associated with the object, a start time input field for a start time of the region in relation to the object, an end time input field for an end time of the region in relation to the object, and a plurality of buttons for editing the outline of the object including a draw shape button, a move shape button, and a clear shape button. The object may include attributes comprising media-defined time and media-defined positional data corresponding to the object. The step of defining the region may occur in relation to the attributes of the object.

Alternative or additional options are contemplated. This may include re-defining a size of the region in response to changes to attributes of the object in the media content. This may include storing the object parameters associated with the re-defined region in a database. Embodiments may include defining a plurality of regions corresponding to respective parts of the object, and a plurality of different durations of time. This may include storing the object parameters associated with the plurality of regions in a database. The drawing of the region without accessing individual frames of the media content may occur without editing individual frames of the media content.

Selection events may include one or a combination of a hover event, a click event, a touch event, a voice event, an image or edge detection event, a user recognition event, or a sensor event. Selection events may occur without utilizing a layer that is separate from the media content. Additional information may be retrieved in response to selection event parameters being within the object parameters associated with the region. Object parameters may be established and re-established in response to changes to the object in the media content. This may occur without editing individual frames of the media content.

Exemplary embodiments may include determining whether the selection event parameters are within the object parameters is further defined as determining whether any part of the selection position corresponding to the selection event is within the user-defined position associated with the object at a given time. Additional information may include advertising information related to the object. Embodiments may include retrieving additional information and displaying additional information including advertising information to the end-viewer.

Embodiments may include user interfaces configured to provide the operations herein. This may include a first window is of a player of the media content and a second window that is separate from the player. This may include updating object parameters in response to the object selected from the media content by the end-viewer device. Embodiments may include updating the object parameters in response to tracking end-viewer preferences including when the object was selected and how many times the object was selected.

Adaptive user interface systems, devices and methods are contemplated. The adaptive user interface system may include a user interface device with memory and a processor communicatively connected to the memory to provide operations comprising receive media content and interactive content, correlate the media content and the interactive content, define an object boundary relative to one or more objects in media content, define interactive regions having a predefined gap relative to the object boundary, and display media content while hiding the interactive regions.

Alternatively or in addition, embodiments may receive a selection event relative to the interactive regions, determine which one of the interactive regions is associated with the selection event, cause display of the selected one of the interactive regions, receive adaptive information from a plurality of other user interface devices, supplement the adaptive information based on the received adaptive information, and synchronize the supplemented adaptive information with the plurality of other user interface devices.

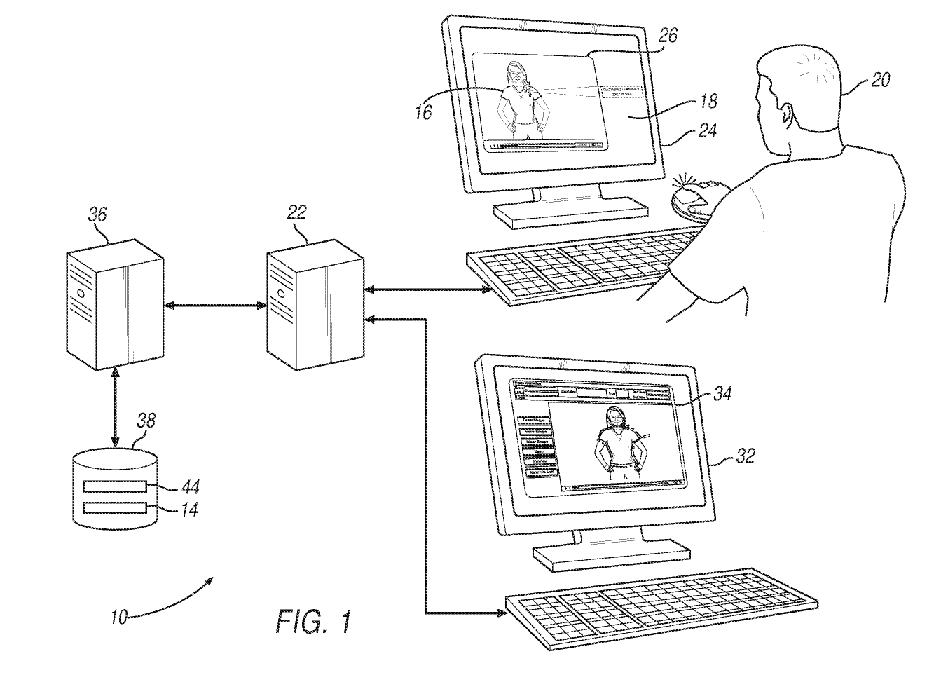

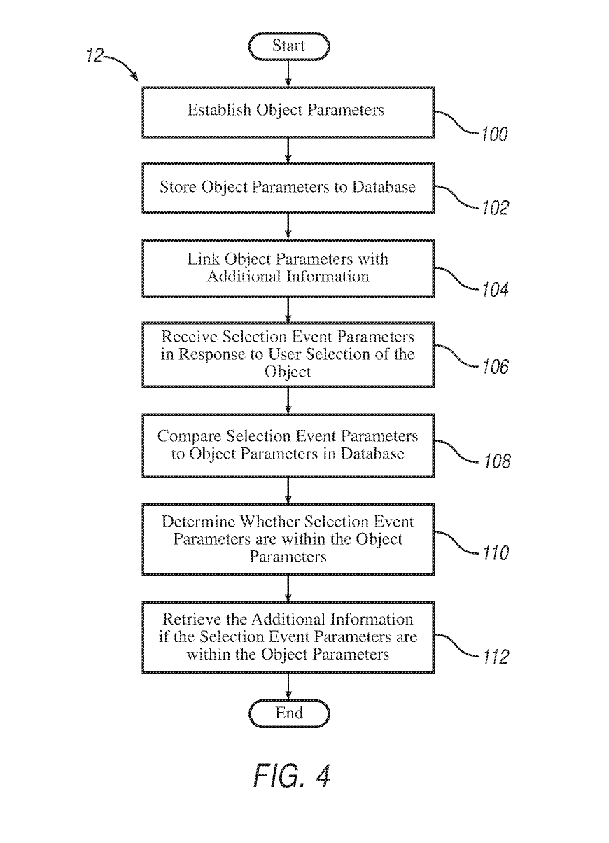

Referring to FIGS. 1-4, a system 10 and a method 12 for providing additional information 14 associated with an object 16 in response to selection of the object 16 in media content 18 by a user 20, are shown generally throughout the Figures. System 10 and method 12 may include any of the components and operations described herein. For example, as described in further detail below, system 10 and method 12 may include devices 201 and servers 202 for employing instructions of program 207 that are stored on memory 205 or database 213 and are executed by processor 203 to provide the operations herein.

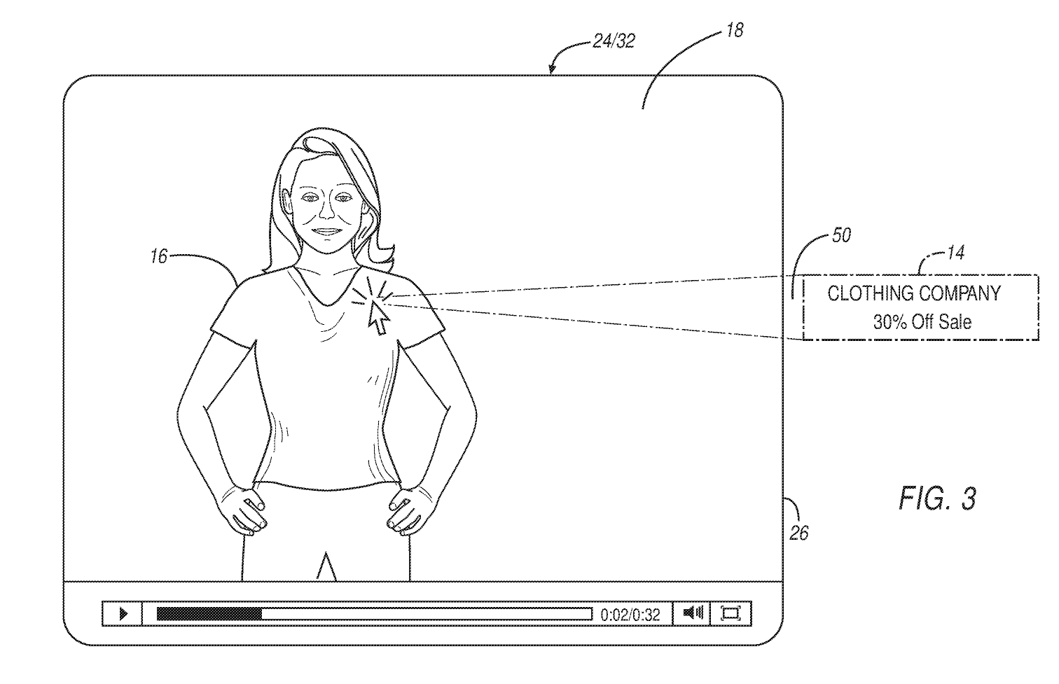

As shown in FIGS. 1 and 3, the user 20 is presented with the media content 18. A content provider typically broadcasts or transmits the media content 18 to the user 20. Examples of the media content 18 include, but are not limited to, recorded or live television programs, movies, sporting events, news broadcasts, and streaming videos.

Transmission of the media content 18 by the content provider may be accomplished by satellite, network, internet, or the like. In one example as shown in FIG. 1, the content provider provides the media content 18 to the user 20 through a web server 22. The system 10 includes a user device 24 for receiving the media content 18 from the web server 22. The user 20 may receive the media content 18 in various types of user devices 24 such as digital cable boxes, satellite receivers, smart phones, laptop or desktop computers, tablets, televisions, and the like. In one example as shown in FIG. 1, the user device 24 is a computer that is in communication with the web server 22 for receiving the media content 18 from the web server 22.

The media content 18 may be streamed such that the media content 18 is continuously or periodically received by and presented to the user 20 while being continuously or periodically delivered by the content provider. The media content 18 may be transmitted in digital form. Alternatively, the media content 18 may be transmitted in analog form and subsequently digitized.

The system 10 further includes a player 26 for playing the media content 18. The player 26 may be integrated into the user device 24 for playing the media content 18 such that the media content 18 is viewable to the user 20. Examples of the player 26 include, but are not limited to, Adobe Flash Player or Windows Media Player, and the like. The media content 18 may be viewed by the user 20 on a visual display, such as a screen or monitor, which may be connected or integrated with the user device 24. As will be described below, the user 20 is able to select the object 16 in the media content 18 through the user device 24 and/or the player 26.

The object 16 is visually present in the media content 18. The object 16 may be defined as any logical item in the media content 18 that is identifiable by the user 20. In one embodiment, the object 16 is a specific item in any segment of the media content 18. For example, within the 30-second video commercial, the object 16 may be a food item, a corporate logo, or a vehicle, which is displayed during the commercial. For simplicity, the object 16 is illustrated as a clothing item throughout the Figures. The object 16 includes attributes including media-defined time and media-defined positional data corresponding to the presence of the object 16 in the media content 18.

As illustrated in FIG. 1, an editing device 32 is connected to the web server 22. In one example, the editing device 32 is a computer such as a desktop computer, or the like. However, the editing device 32 may include any other suitable device. An authoring tool 34 is in communication with the editing device 32. In one embodiment, the authoring tool 34 is a software program that is integrated in the editing device 32. A media server 36 is in communication with the web server 22. In other words, the media server 36 sends and receives signal or information to and from the web server 22. A database 38 is in communication with the media server 36. In other words, the database 38 sends and receives signal or information to and from the media server 36. However, other configurations of the system 10 are possible without departing from the scope of the disclosure.

The media content 18 is provided to the editing device 32. The media content 18 may be provided from the web server 22, the media server 36, or any other source. In one embodiment, the media content 18 is stored in the media server 36 and/or the database 38 after being provided to the editing device 32. In another embodiment, the media content 18 is downloaded to the editing device 32 such that the media content 18 is stored to the editing device 32 itself. In some instances, an encoding engine may encode or reformat the media content 18 to one standardized media type which is cross-platform compatible. As such, the method 12 may be implemented without requiring a specialized player 26 for each different platform.

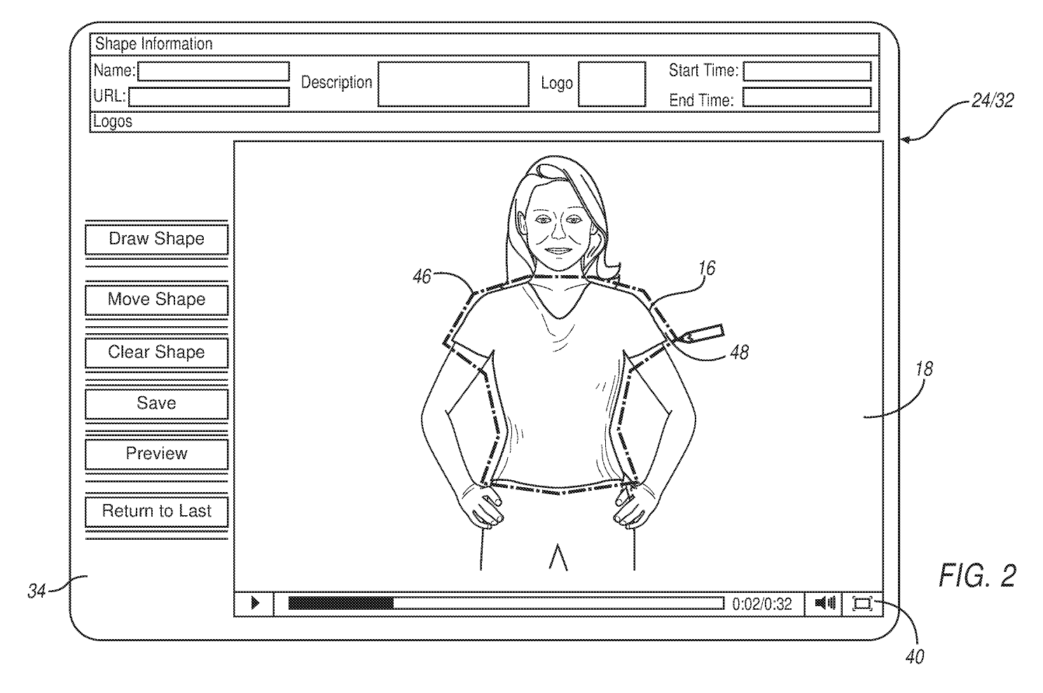

As shown in FIG. 2, the media content 18 is accessed by the authoring tool 34 from the editing device 32. With the authoring tool 34, the media content 18 is displayed in an authoring tool player 40. Here, a user of the editing device 32 can examine the media content 18 to determine which object 16 to associate the additional information 14.

The method 12 includes the step 100 of establishing object parameters 44 associated with the object 16. The object parameters 44 include user-defined time and user-defined positional data associated with the object 16. The user of the editing device 32 utilizes the authoring tool 34 to establish the object parameters 44. It is to be appreciated that “user-defined” refers to the user of the editing device 32 that creates the object parameters 44. According to one embodiment, as shown in FIG. 2, the object parameters 44 are established by defining a region 46 in relation to the object 16. The authoring tool 34 enables the user of the editing device 32 to draw, move, save and preview the region 46 drawn in relation to the object 16. The region 46 is defined generally in relation to the attributes of the object in the media, e.g., media-defined time and media-defined position of the object 16. The region 46 may be drawn with the authoring tool 34 in relation to any given position and time the object 16 is present in the media content 18. For example, as illustrated in FIG. 2, the region 46 is drawn in relation to the object 16 shown as a clothing item that is visibly present in the media content 18 at a given time. The authoring tool player 40 enables the user of the editing device 32 to quickly scroll through the media content 18 to identify when and where a region 46 may be drawn in relation to the object 16.

The region 46 may be drawn in various ways. In one embodiment, the region 46 is drawn to completely surround the object 16. For example, in FIG. 2, the region 46 surrounds the clothing item. The region 46 does not need to correspond completely with the object 16. In other words, the region 46 may surround the object 16 with excess space 48 (e.g., a predefined, varying or substantially constant gap or distance) between an edge of the object 16 and an edge of the region 46. Alternatively, the region 46 may be drawn only in relation to parts of the object 16. A plurality of regions 46 may also be drawn. In one example, the plurality of regions 46 are drawn for various objects 16. In another example, the plurality of regions 46 are defined in relation to one single object 16.

Once the region 46 is drawn in relation to the object 16, object parameters 44 corresponding to the region 46 are established. The object parameters 44 that are established include the user-defined time data related to when the region 46 was drawn in relation to the object 16. The user-defined time data may be a particular point in time or duration of time. For example, the authoring tool 34 may record a start time and an end time that the region is drawn 46 in relation to the object 16. The user-defined time data may also include a plurality of different points in time or a plurality of different durations of time. The user-defined positional data is based on the size and position of the region 46 drawn. The position of the object 16 may be determined in relation to various references, such as the perimeter of the field of view of the media content 18, and the like. The region 46 includes vertices that define a closed outline of the region 46. In one embodiment, the user-defined positional data includes coordinate data, such as X-Y coordinate data that is derived from the position of the vertices of the region 46.

The media content 18 may be advanced forward, i.e. played or fast-forwarded, and the attributes of the object 16 may change. In such instances, the object parameters 44 may be re-established in response to changes to the object 16 in the media content 18, or user or device inputs from one or more devices 201 as described below. The region 46 may be re-defined to accommodate a different size or position of the object 16. Once the region 46 is re-defined, updated object parameters 44 may be established. In one example, object parameters 44 that correspond to an existing region 46 are overwritten by updated object parameters 44 that correspond to the re-defined region 46. In another example, existing object parameters 44 are preserved and used in conjunction with updated object parameters 44. Re-defining the region 46 may be accomplished by clicking and dragging the vertices or edges of the region 46 in the authoring tool 34 to fit the size and location of the object 16.

In one embodiment, the authoring tool 34 provides a data output capturing the object parameters 44 that are established. The data output may include a file that includes code representative of the object parameters 44. The code may be any suitable format for allowing quick parsing through the established object parameters 44. However, the object parameters 44 may be captured according to other suitable methods. It is to be appreciated that the term “file” as used herein is to be understood broadly as any digital resource for storing information, which is available to a computer process and remains available for use after the computer process has finished.

The step 100 of establishing object parameters 44 does not require accessing individual frames of the media content 18. When the region 46 is drawn, individual frames of the media content 18 need not be accessed or manipulated. Instead, the method 12 enables the object parameters 44 to be established easily because the regions 46 are drawn in relation to time and position, rather than individual frames of the media content 18. In other words, the object parameters 44 do not exist for one frame and not the next. So long as the region 46 is drawn for any given time, the object parameters 44 will be established for the given time, irrespective of anything having to do with frames.

At step 102, the object parameters 44 are stored in the database 38. As mentioned above, the object parameters 44 are established and may be outputted as a data output capturing the object parameters 44. The data output from the authoring tool 34 is saved into the database 38. For example, the file having the established object parameters 44 encoded therein may be stored in the database 38 for future reference. In one example as shown in FIG. 1, the object parameters 44 are stored in the database 38 through a chain of communication between the editing device 38, the web server 22, and the media server 36, and the database 38. However, various other chains of communication are possible, without deviation from the scope of the disclosure.

The method 12 allows for the object parameters 44 to be stored in the database 38 such that the region 46 defined in relation to the object 16 need not be displayed over the object 16 during playback of the media content 18. Thus, the method 12 does not require a layer having a physical region that tracks the object 16 in the media content 18 during playback. The regions 46 that are drawn in relation to the object 16 in the authoring tool 34 exist only temporarily to establish the object parameters 44. Once the object parameters 44 are established and stored in the database 38, the object parameters 44 may be accessed from the database 38 such that the regions 46 as drawn are no longer needed. It is to be understood that the term “store” with respect to the database 38 is broadly contemplated by the present disclosure. Specifically, the object parameters 44 in the database 38 may be temporarily cached, and the like.

In some instances, the object parameters 44 that are in the database 38 need to be updated. For example, one may desire to re-define the positional data of the region 46 or add more regions 46 in relation to the object 16 using the authoring tool 34. In such instances, the object parameters 44 associated with the re-defined region 46 or newly added regions 46 are stored in the database 38. In one example, the file existing in the database 38 may be accessed and updated or overwritten.

The database 38 is configured to have increasing amounts of object parameters 44 stored therein. Mainly, the database 38 may store the object parameters 44 related to numerous different media content 18 for which object parameters 44 have been established in relation to objects 16 in each different media content 18. In one embodiment, the database 38 stores a separate file for each separate media content 18 such that once a particular media content 18 is presented to the user 20, the respective file having the object parameters 44 for that particular media content 18 can be quickly referenced from the database 38. As such, the database 38 is configured for allowing the object parameters 44 to be efficiently organized for various media content 18.

At step 104, the object parameters 44 are linked to the additional information 14. The additional information 14 may include advertising information, such as brand awareness and/or product placement-type advertising. Additionally, the additional information 14 may be commercially related to the object 16. In one example, as shown in FIG. 3, the additional information 14 is an advertisement commercially related to the clothing item presented in the media content 18. The additional information 14 may be linked to the object parameters 44 according to any suitable means, such as by a link. The additional information 14 may take the form of a uniform resource locator (URL), an image, a creative, and the like.

The additional information 14 may be generated using the authoring tool 34. In one embodiment, as shown in FIG. 2, the authoring tool 34 includes various inputs allowing a user of the editing device 32 to define the additional information 14. For instance, the URL that provides a link to a website related to the object 16 may be inputted in relation to the defined region 46. The URL provides the user 20 viewing the media content 18 access to the website related to the additional information 14 once the user 20 selects the object 16. A description of the additional information 14 or object 16 may also be defined. The description provides the user 20 of the media content 18 with written information related to the additional information 14 once the user 20 selects the object 16. For example, the description may be a brief message explaining the object 16 or a promotion related to the object 16. Additionally, an image, logo, or icon related to the additional information 14 may be defined. The user 20 viewing the media content 18 may be presented with the image related to the additional information 14 once the object 16 is selected by the user 20. Additional information may be interchangeably referred to as interactive events, interactive content or target content.

The additional information 14 linked with the object parameters 44 may be stored in the database 38. Once the additional information 14 is defined, the corresponding link, description, and icon may be compiled into a data output from the authoring tool 34. In one embodiment, the data output related to the additional information 14 is provided in conjunction with the object parameters 44. For example, the additional information 14 is encoded in relation to the object parameters 44 that are encoded in the same file. In another example, the additional information 14 may be provided in a different source that may be referenced by the object parameters 44. In either instance, the additional information 14 may be stored in the database 38 along with the object parameters 44. As such, the additional information 14 may be readily accessed without requiring manipulation of the media content 18.

Once the object parameters 44 are established and linked with the additional information 14, the media content 18 is no longer required by the editing device 32, the authoring tool 34, or the media server 36. The media content 18 can be played separately and freely in the player 26 to the user 20 without any intervention by the editing device 32 or authoring tool 34. Generally, the media content 18 is played by the player 26 after the object parameters 44 are established such that the method 12 may reference the established object parameters 44 in response to user 20 interaction with the media content 18.

As mentioned above, the user 20 is able to select the object 16 in the media content 18. When the user 20 selects the object 16 in the media content 18, a selection event is registered. The selection event may be defined as a software-based event whereby the user 20 selects the object 16 in the media content 18. The user device 24 that displays the media content 18 to the user 20 may employ various forms of allowing the user 20 to select the object 16. For example, the selection event may be further defined as a hover event, a click event, a touch event, a voice event, an image or edge detection event, a user recognition event, a sensor event, or any other suitable event representing the user's 20 intent to select the object 16. The selection event may be registered according to any suitable technique.

At step 106, selection event parameters are received in response to the selection event by the user 20 selecting the object 16 in the media content 18 during playback of the media content 18. It is to be appreciated that the user 20 that selects the object 16 in the media content 18 may be different from the user 20 of the editor. Preferably, the user 20 that selects the object 16 is an end viewer of the media content 18. The selection event parameters include selection time and selection positional data corresponding to the selection event. The time data may be a particular point in time or duration of time during which the user 20 selected the object 16 in the media content 18. The positional data is based on the position or location of the selection event in the media content 18. In one embodiment, the positional data includes coordinate data, such as X-Y coordinate data that is derived from the position or boundary of the selection event. The positional data of the selection event may be represented by a single X-Y coordinate or a range of X-Y coordinates. It is to be appreciated that the phrase “during playback” does not necessarily mean that the media content 18 must be actively playing in the player 26. In other words, the selection event parameters may be received in response to the user 20 selecting the object 16 when the media content 18 is stopped or paused.

The selection event parameters may be received in response to the user 20 directly selecting the object 16 in the media content 18 without utilizing a layer that is separate from the media content 18. The method 12 advantageously does not require a layer having a physical region that tracks the object 16 in the media content 18 during playback. Accordingly, the selection event parameters may be captured simply by the user 20 selecting the object in the media content 18 and without attaching additional functionality to the media content 18 and/or player 26.

The selection event parameters may be received according to various chains of communication. In one embodiment, as shown in FIG. 1, the selection event occurs when the user 20 selects the object 16 in the player 26 of the user device 24. The selection event parameters corresponding to the selection event are transmitted through the web server 22 to the media server 36. In one embodiment, the selection event parameters are ultimately received at the media server 36. In another embodiment, the selection event parameters are ultimately received at the database 38.

Once the selection event parameters are received, the method 12 may include the step of accessing the object parameters 44 from the database 38 in response to the selection event. In such instances, the method 12 may implicate the object parameters 44 in response to or only when a selection event is received. By doing so, the method 12 efficiently processes the selection event parameters without requiring continuous real-time synchronization of between the object parameters 44 in the database 38 and the media content 18. In other words, the method 12 advantageously references the object parameters 44 in the database 38 when needed, thereby minimizing any implications on the user device 24, the player 26, the media server 36, the web server 22, and the media content 18. The method 12 is able to take advantage of the increase in today's computer processing power to reference on-demand the object parameters 44 in the database 38 upon the receipt of selection event parameters from the user device 24.

At step 108, the selection event parameters are compared to the object parameters 44 in the database 38. The method 12 compares the user-defined time and user-defined positional data related to the region 46 defined in relation to the object 16 with the selection positional and selection time data related to the selection event. Comparison between the selection event parameters and the object parameters 44 may occur in the database 38 and/or the media server 36. The selection event parameters may be compared to the object parameters 44 utilizing any suitable means of comparison. For example, the media server 36 may employ a comparison program for comparing the received selection event parameters to the contents of the file having the object parameters 44 encoded therein.

At step 110, the method 12 determines whether the selection event parameters are within the object parameters 44. In one embodiment, the method 12 determines whether the selection time and selection positional data related to selection event parameters correspond to the user-defined time and user-defined positional data related to the region 46 defined in relation to the object 16. For example, the object parameters 44 may have time data defined between 0:30 seconds and 0:40 seconds during which the object 16 is visually present in the media content 18 for a ten-second interval. The object parameters 44 may also have positional data with Cartesian coordinates defining a square having four vertices spaced apart at (0, 0), (0, 10), (10, 0), and (10, 10) during the ten-second interval. If the received selection event parameters register time data between 0:30 seconds and 0:40 seconds, e.g., 0:37 seconds, and positional data within the defined square coordinates of the object parameters 44, e.g., (5, 5), then the selection event parameters are within the object parameters 44. In some embodiments, both time and positional data of the selection event must be within the time and positional data of the object parameters 44. Alternatively, either one of the time or positional data of the selection event parameters need only be within the object parameters 44.

The step 110 of determining whether the selection event parameters are within the object parameters 44 may be implemented according to other methods. For example, in some embodiments, the method 12 determines whether any part of the positional data corresponding to the selection event is within the positional data associated with the object 16 at a given time. In other words, the positional data of the selection event need not be encompassed by the positional data corresponding to the outline of the region 46. In other embodiments, the positional data of the selection event may be within the positional data of the object parameters 44 even where the selection event occurs outside the outline of the region 46. For example, so long as the selection event occurs in the vicinity of the outline of the region 46 but within a predetermined tolerance, the selection event parameters may be deemed within the object parameters 44.

At step 112, the additional information 14 linked to the object parameters 44 is retrieved if the selection event parameters are within the object parameters 44. In one embodiment, the additional information 14 is retrieved from the database 38 by the media server 36. Thereafter, the additional information 14 is provided to web server 22 and ultimately to the user device 24.

The additional information 14 is displayable to the user 20 without interfering with playback of the media content 18. The additional information 14 may become viewable to the user 20 according to any suitable manner. For instance, as shown in FIG. 3, the additional information 14 is viewable at the side of the player 26 such that the view of the media content 18 is unobstructed. Alternatively, the additional information 14 may become viewable directly within the player 26. The additional information 14 may be displayed in at least one of the player 26 of the media content 18 and a window separate from the player 26.

As mentioned above, the additional information 14 may include advertising information related to the object 16. In one example, as shown in FIG. 3, the additional information 14 is displayed without interfering with playback of the media content 18. The additional information 14 includes the icon, description, and link previously defined by the authoring tool 34. Once the user 20 selects the additional information 14, the user 20 may be directed to a website or link having further details regarding the object 16 selected. As such, the method 12 advantageously provides advertising that is uniquely tailored to the desires of the user 20.

The method 12 may include the step of collecting data related to the object 16 selected by the user 20 in the media content 18. The method 12 may be beneficially used for gathering valuable data about the user's preferences. The data related to the object 16 selected may include what object 16 was selected, when an object 16 is selected, and how many times an object 16 is selected. The method 12 may employ any suitable technique for collecting such data. For example, the method 12 may analyze the database 38 and extract data related to object parameters 44, additional information 14 linked to object parameters 44, and recorded selection events made in relation to particular object parameters 44.

The method 12 may further include the step of tracking user 20 preferences based upon the collected data. The method 12 may be utilized to monitor user 20 behavior or habits. The collected data may be analyzed for monitoring which user 20 was viewing and for how long the user 20 viewed the object 16 or the media content 18. The collected data may be referenced for a variety of purposes. For instance, the object parameters 44 may be updated with the additional information 14 that is specifically tailored to the behavior or habits of the user 20 determined through analysis of the collected data related to the user's 20 past selection events.

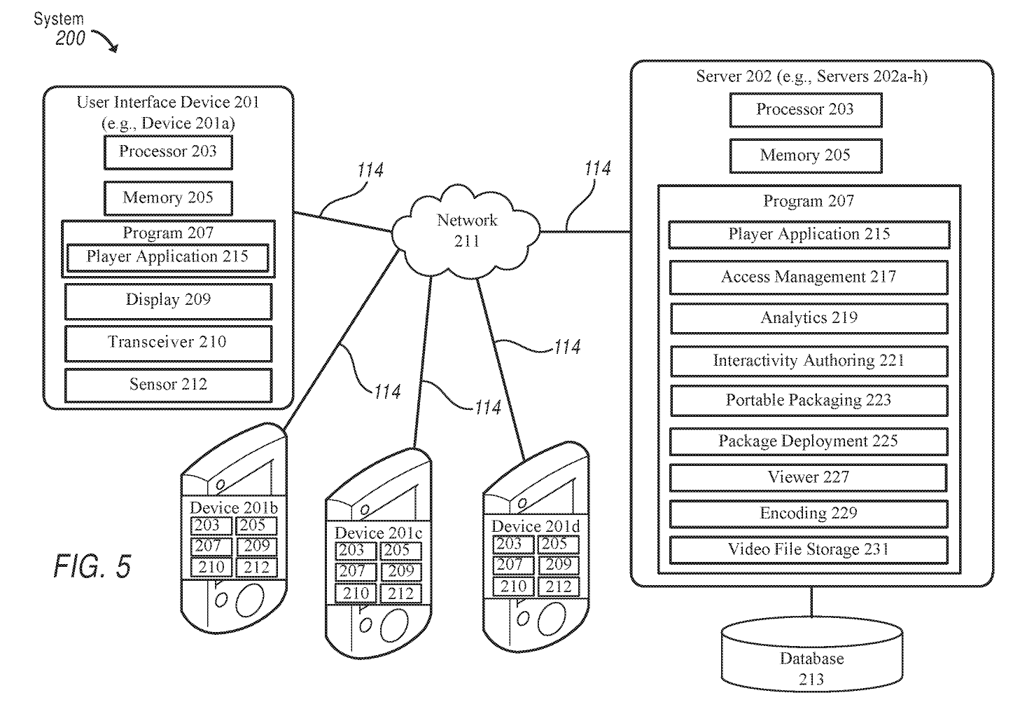

As illustrated in FIG. 5, the system 200 may include any of the components and operations described herein. System 200 may include one or more interface device 201 (e.g., devices 201a-d), server 202 (e.g., servers 202a-h), processor 203 (e.g., a hardware processor), memory 205 (e.g., physical memory), program 207, display 109 (e.g., a hardware display), transceiver 210, sensor 212 (e.g., to receive user inputs such as text, voice or touch and device inputs such as geolocation information using a global positioning system (GPS)), database 213, and connections 214. The devices 201 and servers 202 may include processor 205 and memory 207 including program 207 for user interface screens by way of display 209 and that are generated by way of instructions on memory 207 that when executed by processor 205 provide the operations described herein. For example, device 201 may include user device 24, editing device 32, or a combination thereof, server 201 may include web server 22, editing device 32, media server 36 or a combination thereof, program 207 may include player 26, authoring tool 34, or a combination thereof, and database 38 may include database 213.

The operations herein may be performed with respect to additional information as described above, also referred to interchangeably as interactive content or target content. For example, interactive content may be based on or include a correlation between media content and interactive or target content. Interactive content may include and be adapted based on adaptive information. Interactive content may be updated and synchronized by one or a plurality of devices 201 and servers 202.

The system 200 may be configured to transfer and adapt interactive content throughout the system 200 by way of connections 214. The system 200, e.g., devices 201 and servers 202, may be configured to receive and send (e.g., using transceiver 210), transfer (e.g., using transceiver 210 and/or network 211), compare (e.g., using processor 203), and store (e.g., using memory 205 and/or databases 213) with respect to devices 201 and servers 202. Devices 201 and servers 202 may be in communication with each other to adapt and evolve the interactive content by the respective processors 203. The memory 205 and database 213 may store and transfer interactive content. Each memory 205 and database 213 may store the same or different portions of the interactive content, which may be updated, adapted, aggregated and synchronized by processor 203.

Program 207 may be stored by memory 205 and database 213, exchange inputs and outputs with display 208, and be executed by processor 203 of one or a plurality of devices 201 and servers 202. Program 207 may include player application 215 (e.g., displays media and target content and transfer inputs and outputs of devices 201), access management 217 (e.g., providing secure access to memory 205 and database 213), analytics 219 (e.g., generate analytics or adaptive information such as correlations between objects and interactive content according to devices 201 and servers 202), interactivity authoring 221 (e.g., generating interactive regions relative to objects), portable packaging 223 (e.g., generating and packaging media content and interactive content), package deployment 225 (e.g., generating and transferring information between devices 201 and servers 202), viewer 227 (e.g., displays media content on devices 201), encoding 229 (e.g., encodes media content of devices 201 and servers 202), and video file storage 231 (stores information of devices 201 and servers 202). All or any portions of program 207 may be executed on one or a plurality of local, remote or distributed processors 203 of devices 201, servers 202, or a combination thereof.

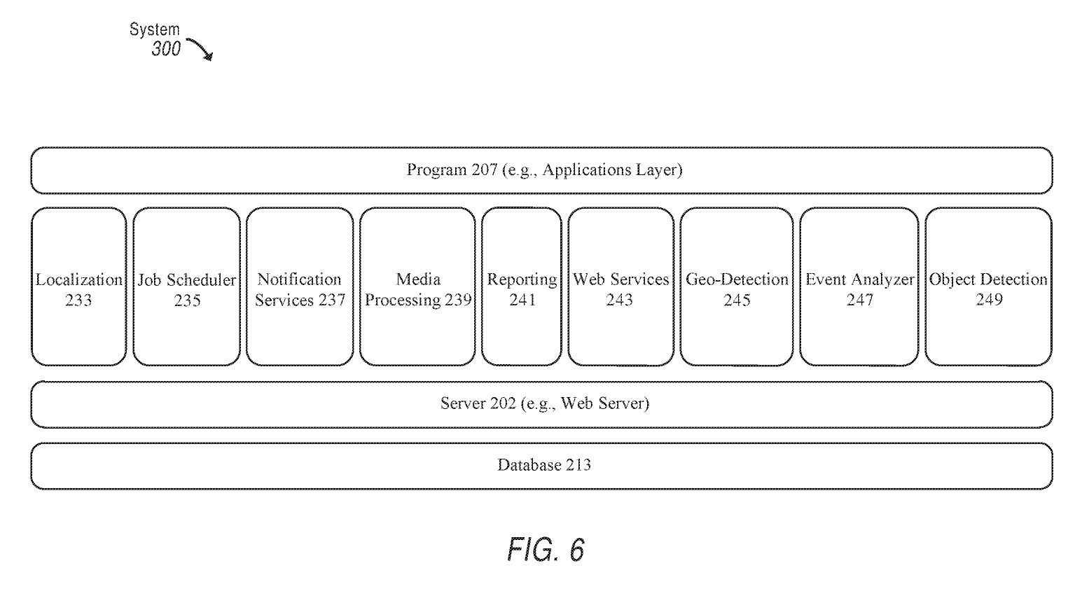

As shown in FIG. 6, system 300 may include any of the components and operations described herein. System 200 may include program 207 may provide a variety of services to server 202 (e.g., web server) and devices 201, and may be communicatively connected to database 213 and memory 205. Program 207 may alternatively or additionally include any or all of localization 233 (e.g., determines the location of a user device based on an internet protocol (IP) address or geolocation of a global positioning system (GPS), delivers appropriate instructions and interface language, and generates analytics including and by recording a date, a time, a device location, and/or device and user inputs), job scheduler 235 (e.g., performs housekeeping and analytics updates), notification services 237 (e.g., generates response messages for completed jobs, uploads and encodes), media processing 239 (e.g., processes video data to support multiple output streams), reporting 241 (e.g., analytics and management reporting), web services 243 (e.g., service handlers designed to support application programming interface (API) connectivity to other devices 201 and servers 202, and standard web services designed to support web based interfaces), geo-detection 245 (e.g., detects and reports device location for localization and analytical data reporting), event analyzer 247 (e.g., creates events used in the portable package file, and generates requests and responses to user selections such as what happens when someone hovers or clicks on or off of an object 16 having a boundary, outline or shape), and object detection 249 (e.g., creates object mapping for portable package file, used in conjunction with events to provide response to user selections, and performs shape determination) Program 207 may be stored on and access information from database 213 and memory 205.

Server 202, e.g., a web server, may be responsible for communications of interactive information such as events, responses, target content, and other actions between servers 202 (e.g., a backend server) and devices 201 (e.g., using player application 215). This may be via a graphical user interface (GUI), an event area of a webpage via server 202 (e.g., web server), or a combination thereof. Server 202 may include components used to communicate with one or more computing platforms, user devices 201, severs 202, and network 211.

Database 213 may be adapted for storing any information as described herein. Database 213 may store business rules, response rules, instructions and/or pointer data for enabling interactive and event driven content. Database 213 may include a rules database for storing business rules, response rules, instructions and/or pointer data for use in generating event-driven content enabled upon a source file. Database 213 may be one or a plurality of databases 213.

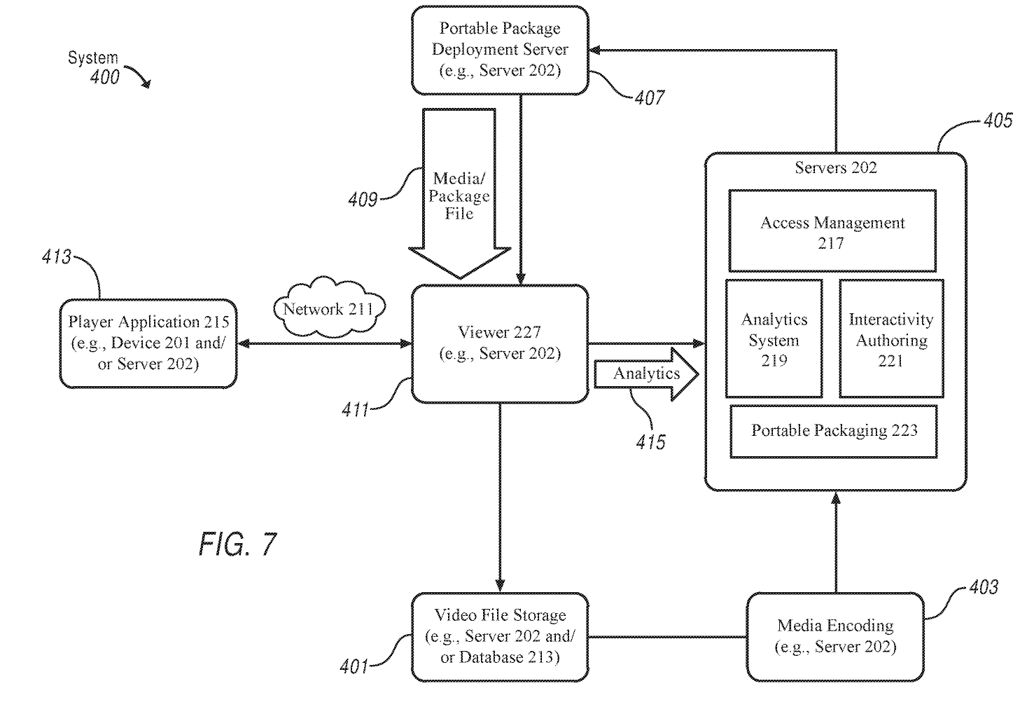

Referring to FIG. 7, system 400 may include any of the components and operations described herein, e.g., to generate analytics or adaptive information. System 400 may include devices 201 and server 202 with program 207 stored on memory 205 or database 213 and executed by processor 203 to provide the operations herein. At block 401, media content may be stored using server 202, database 213, and memory 205. At block 403, the same or another server 202 may perform media encoding of media content. At block 405, the same or another server 202 may generate and combine media content and interactive content in a packaging file using access management 217, analytics 219, interactivity authoring 221, and portable packaging 223. At block 207, the same or another server 202 may transfer or deploy the packaging file to viewer 227. At arrow 409, the packaging file is being transferred to viewer 227. At block 411, the packaging file is received by the viewer 227. At block 413, the package file is received and played on player application 215. Again, at block 411, analytics information is received by viewer 227. At arrow 415, analytics information is sent to servers 202. Again, at block 405, analytics 415 are transferred to and updated on servers 202.

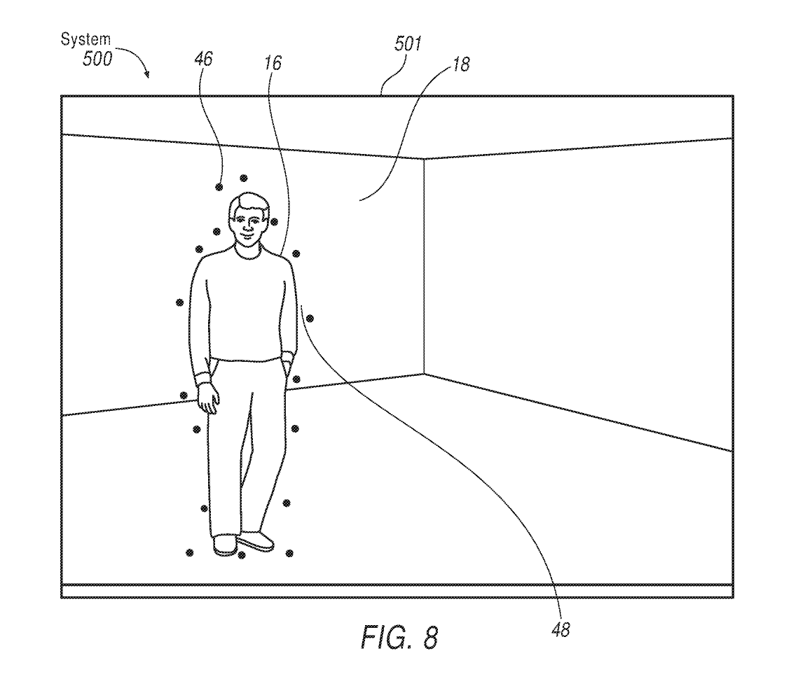

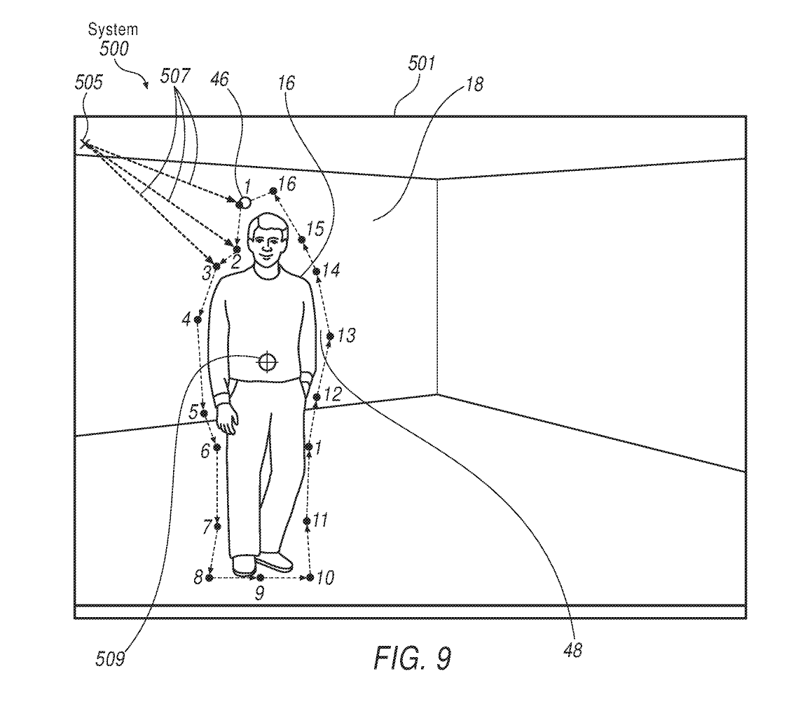

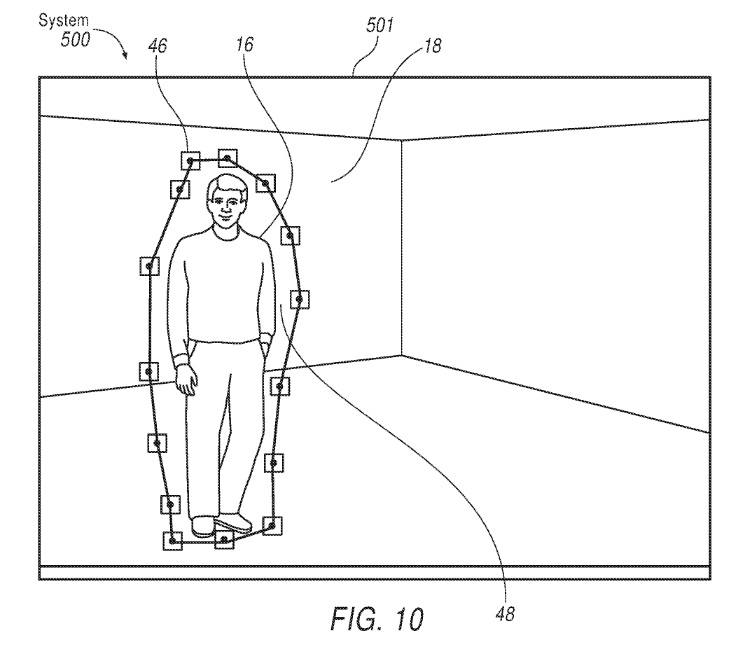

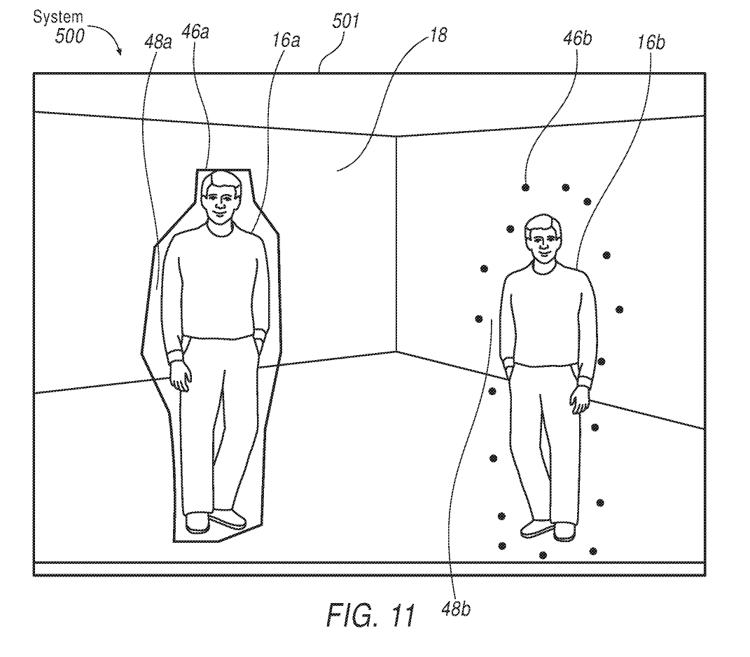

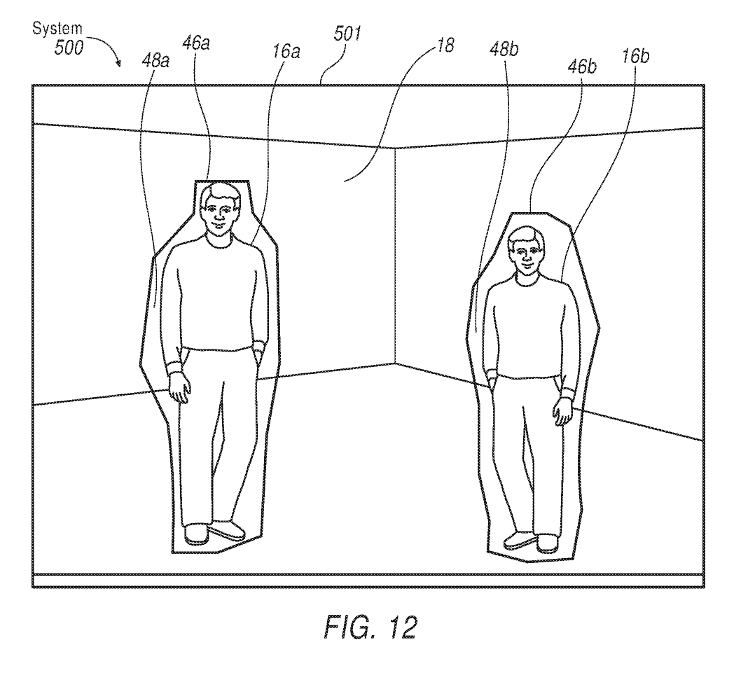

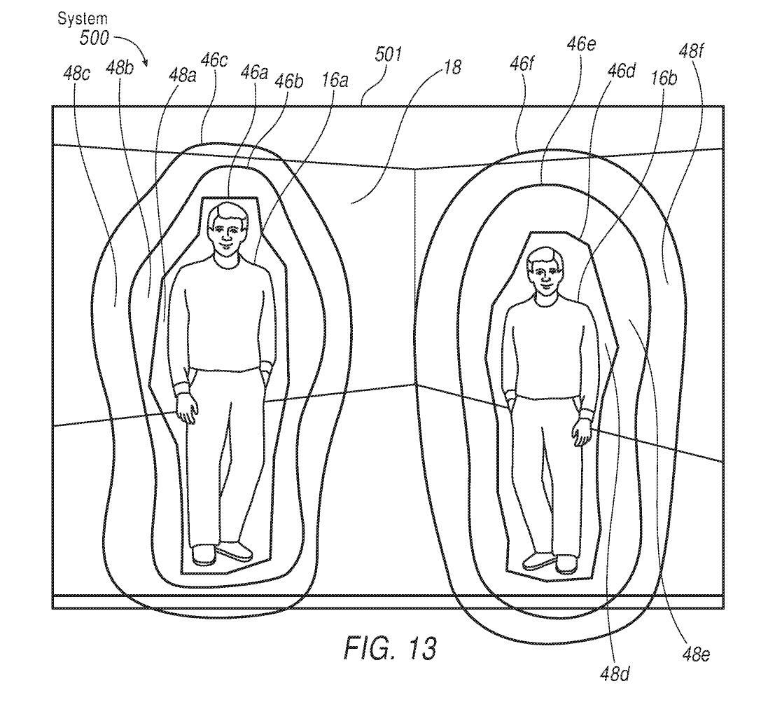

With reference to FIGS. 8-13, system 500 may include any of the components and operations described herein, e.g., devices 201 with display 209 to display screen 501. Screen 501 may be displayed on display 209 and generated by processor 203 executing instructions of program 207 using information stored on memory 205 and database 213. As shown in FIG. 8, display 209 may include region 46 with a plurality of points relative to object 16 with an excess space 48 (a predefined, varying, or substantially constant gap or distance) between an edge of the object 16 and an edge of the region 46. The edges of object 16 and region 46 may be automatically or user defined by device 201, server 202, a plurality of devices 201 or servers 202, or a combination thereof. The excess space 48 may be any distance or gap outside or inside object 16. As shown in FIG. 9, display 209 may include region 46 with a plurality of points enclosed by lines to form an outline. Region 46 may be positioned relative to origin 505 and at respective distances 507 from origin 505. Region 46 may include a central region 509. As shown in FIG. 10, display 209 may include region 46 with a plurality of points encompassed by respective mini-regions and connected by lines. As shown in FIG. 11, display 209 may include region 46 with a first region 46a relative to a first object 16a and a second region 46b relative to a second object 16b. As seen in comparing FIGS. 11 and 12, display 209 may include the first and second objects 16a, 16b with the same or different types of regions 46a, 46b and may have the same or different excess spaces 48a, 48b. As shown in FIG. 13, display 209 may include regions 46a, 46b, 46c at different spaces 48a, 48b, 48c relative to an edge of object 16a, and regions 46d, 46e, 46f at different spaces 48d, 48e, 48f relative to an edge of object 16b.

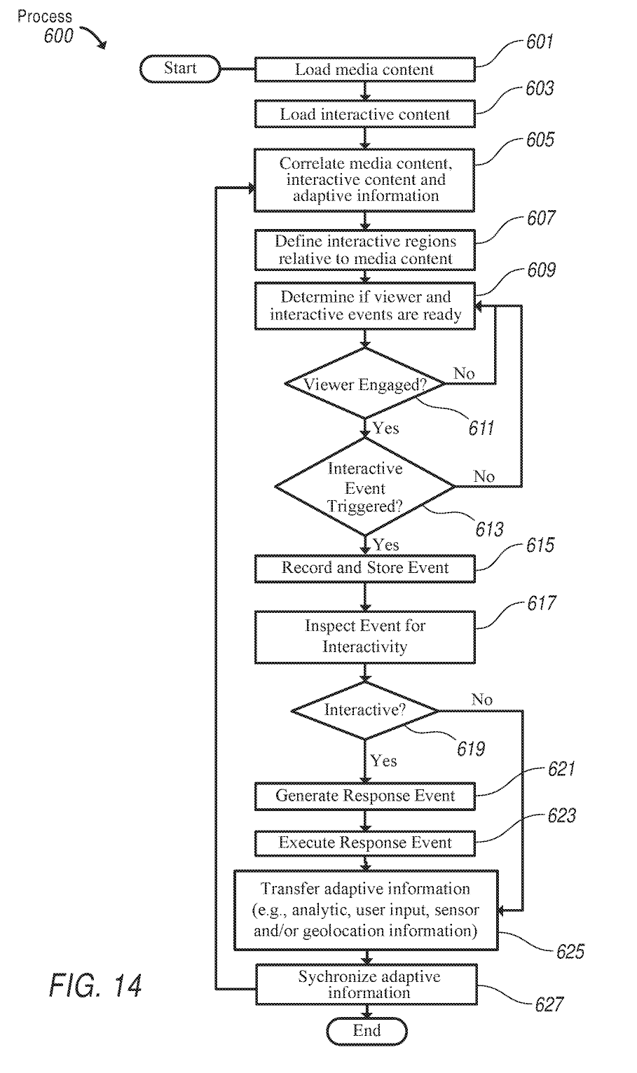

Referring to FIG. 14, process 600 may include any of the components and operations described herein. Process 600 may include instructions of program 207 that are stored on memory 205 or database 213 and are executed by processor 203 to provide the operations herein. At step 601, processor 207 may receive and load media content from memory 205 or database 213. At step 603, processor 207 may receive and load interactive content (e.g., including interactive events) from memory 205 or database 213. At step 605, processor 207 may correlate media content, interactive content, and adaptive information from devices 201 and servers 203. At step 607, processor 207 may define interactive regions relative to media content. At step 609, processor 207 may determine if viewer 227 and interactive events are ready. At step 611, processor 207 may determine if viewer 227 is engaged, and repeat step 609 if not engaged or perform step 613 if engaged. At step 613, processor 613 may determine if an interactive event is triggered and repeat step 609 if not triggered and perform step 615 if triggered. At step 615, processor may record the interactive event and store the interactive event to memory 205 or database 113. At step 617, processor 207 may inspect the interactive event for interactivity, and if not interactive perform step 625 and if interactive perform step 621. At step 621, processor 207 may generate a response event. At step 623, processor 207 may execute the response event. At step 625, processor 207 may transfer adaptive information to network 111, e.g., analytic, user input, sensor, and/or geolocation information. At step 627, processor 207 may synchronize and update adaptive information. After step 627, processor 207 may revert to step 605 or end process 600.

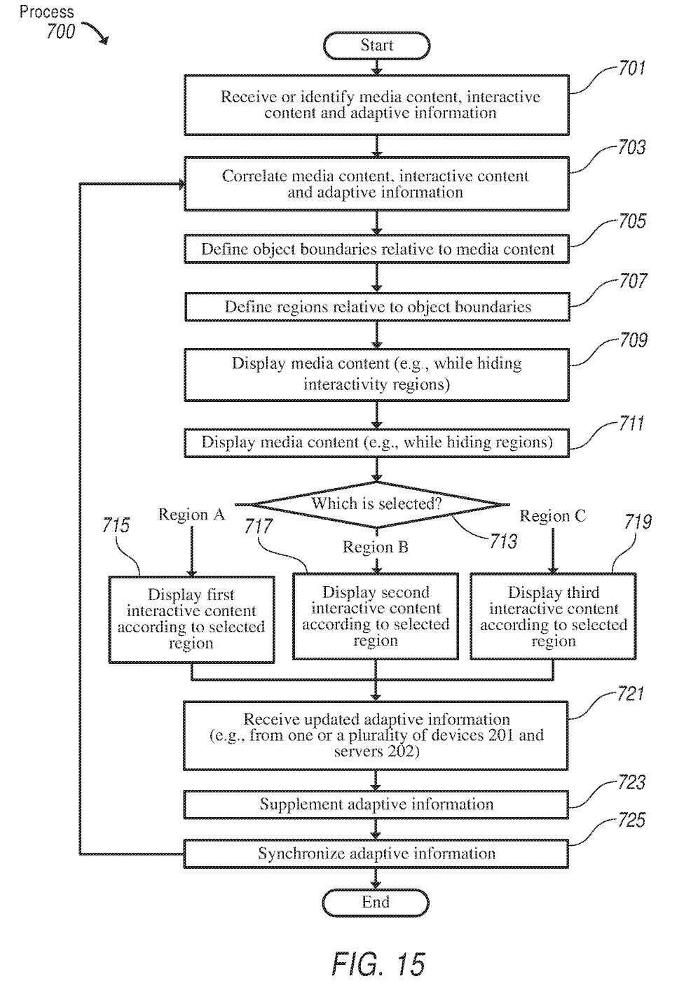

Referring to FIG. 15, process 700 may include any of the components and operations described herein. Process 700 may include instructions of program 207 that are stored on memory 205 or database 213 and are executed by processor 203 to provide the operations herein. At step 701, processor 203 may receive or identify media content, interactive content and adaptive information from memory 205 or database 213. At step 703, processor 203 may correlate mediate content, interactive content, and adaptive information. At step 705, processor 203 may define boundaries relative to one or more object 16 in media content. At step 707, processor 203 may define regions 46 relative to one or more objects 16. At step 709, processor 203 may cause display 209 to display media content, e.g., while hiding regions 46. At step 711, processor 203 or display 209 may receive a selection event from device 203 relative to media content, e.g., while hiding regions. At step 713, processor 203 may determine which of regions 46 is selected. At steps 715, 717, and 719, processor 203 may cause display 209 to display interactive content according to the selected region 46. At step 721, processor 207 may receive adaptive information from network 211 in communication with one or a plurality of devices 201 and servers 202. At step 723, processor 207 may supplement adaptive information on memory 205 or database 113. At step 725, processor 207 may synchronize adaptive information with network 211. After step 725, processor 203 may revert to step 703 or process 700 may end.

While the disclosure has been described with reference to exemplary embodiments, artisans readily understand that each of these are non-essential options and any of the components, arrangements and steps may be added, removed or combined with any one or more of the embodiments herein. Various changes, modifications, adaptations, substitutions, combinations and equivalents are contemplated without departing from the scope of the disclosure. This disclosure is not limited to the particular embodiments and best modes of this disclosure, but it includes all embodiments within the full breadth of this disclosure as understood by artisans and including the drawings and the claims.

What is claimed is:

1. An adaptive user interface system including a user interface device with memory and a processor communicatively connected to the memory to provide operations comprising:
receive media content and interactive content;
correlate the media content and the interactive content;
define an object boundary relative to one or more objects in media content;
define interactive regions having a predefined gap relative to the object boundary; and
display media content while hiding the interactive regions.

2. The system of claim 1, further comprising receives a selection event relative to the interactive regions.

3. The system of claim 2, further comprising determine which one of the interactive regions is associated with the selection event.

4. The system of claim 3, further comprising cause display of the selected one of the interactive regions.

5. The system of claim 1, further comprising receives adaptive information from a plurality of other user interface devices.

6. The system of claim 5, further comprising supplement the adaptive information based on the received adaptive information.

7. The system of claim 6, further comprising synchronizing the supplemented adaptive information with the plurality of other user interface devices.

8. An adaptive user interface having operations comprising:
receive media content and interactive content;
correlate the media content and the interactive content;
define an object boundary relative to one or more objects in media content;
define interactive regions having a predefined gap relative to the object boundary; and
display media content while hiding the interactive regions.

9. The adaptive user interface of claim 8, further comprising receive a selection event relative to the interactive regions.

10. The adaptive user interface of claim 8, further comprising determine which one of the interactive regions is associated with the selection event.

11. The adaptive user interface of claim 10, further comprising cause display of the selected one of the interactive regions.

12. The system of claim 8, further comprising receive adaptive information from a plurality of other user interface devices.

13. The system of claim 12, further comprising supplement the adaptive information based on the received adaptive information.

14. The system of claim 13, further comprising synchronize the supplemented adaptive information with the plurality of other user interface devices.

15. A method of an adaptive user interface comprising:
receiving media content and interactive content;
correlating the media content and the interactive content;
defining an object boundary relative to one or more objects in media content;
defining interactive regions having a predefined gap relative to the object boundary; and
displaying media content while hiding the interactive regions.

16. The method of claim 15, further comprising receiving a selection event relative to the interactive regions.

17. The method of claim 15, further comprising determining which one of the interactive regions is associated with the selection event.

18. The method of claim 17, further comprising causing display of the selected one of the interactive regions.

19. The method of claim 15, further comprising receiving adaptive information from a plurality of other user interface devices.

20. The method of claim 19, further comprising supplementing the adaptive information based on the received adaptive information, and synchronizing the supplemented adaptive information with the plurality of other user interface devices.
